(19) United States
(12) Patent Application Publication
(10) Pub. No.: US 2012/0234186 A1
(43) Pub. Date: Sep. 20, 2012

(54) MILK FROTHER FOR AUTOMATIC HOT-DRINK MACHINE

(76) Inventors: Joerg Krug, Steffenberg (DE); Clemens Klueppel, Neuenrade (DE)

(21) Appl. No.: 13/219,686

(22) Filed: Aug. 28, 2011

(30) Foreign Application Priority Data
Aug. 27, 2010 (DE) 102010035638.7

(51) Int. Cl. A47J 31/44

(52) U.S. Cl. 99/453

(57) ABSTRACT

In order to provide a device for frothing milk in a hot beverage machine, at least comprising a milk frothing nozzle, in which milk can be heated by means of steam produced externally or internally in the device and can be mixed with ambient air, preferably using the principle of a jet pump, the milk frothing nozzle comprising at least a driving nozzle, an air duct for supplying ambient air, one connection each for supplying steam as driving agent and milk, and an outlet for milk foam, wherein the contamination of the air duct by milk is as far as possible prevented, it is proposed that the air duct is integrated in the driving nozzle and has an inner diameter of at least 1 mm, and that in a section of the air duct outside of the driving nozzle, an air nozzle with a reduced cross-section is arranged. Single drawing.

The invention relates to a device for frothing milk in a hot beverage machine, at least comprising a milk frothing nozzle, in which milk can be heated by means of steam produced externally or internally in the device and can be mixed with ambient air, preferably using the principle of a jet pump, the milk frothing nozzle comprising at least a driving nozzle, an air duct for supplying ambient air, one connection each for supplying steam as driving agent and milk, and an outlet for milk foam.

Today's hot beverage machines fulfill the consumer's wish to make hot beverages as mixed milk beverages of different kinds available. For instance mixed milk beverages such as Cappuccino or milk coffee are often sought after by the consumer.

For this purpose, corresponding hot beverage machines are equipped with a device for producing hot steam, which heat and froth milk by means of a milk frothing nozzle using the principle of a jet pump and after addition of coffee make the desired mixed milk beverage available.

In doing so, the mixing ratio of milk to air has a very large effect on the consistency of the milk foam and must precisely be adjusted. Therefore, the air duct in the prior art solutions has a very small cross-section, for instance of a few tenths millimeters. Since milk coagulates by heating, it often occurs that the air duct becomes contaminated or even plugged, so that the desired function is not given anymore.

Based on the state of the art mentioned above, it is the object of the present invention to provide a device for frothing milk in a hot beverage machine, wherein a contamination of the air duct is as far as possible prevented, wherein the risk of leakages and the ingress of false air is minimized, wherein in addition the sensitive air nozzle is protected in the housing of the device, wherein the amount of air and thus the consistency of the milk foam can be adjusted manually or if applicable electrically by the control system of the device, and wherein if applicable the air duct can quickly and simply be cleaned.

For achieving this object, the invention proposes that the air duct is integrated in the driving nozzle and has an inner diameter of at least 1 mm, and that in a section of the air duct outside of the driving nozzle an air nozzle with a reduced cross-section is arranged.

In such a solution, the air duct in the interior of the driving nozzle is separated from the milk supply, thereby a contamination of the air duct and thus a functional limitation being as far as possible prevented. In addition, by the relatively large cross-section of the air duct, a disturbance by milk remainders collecting within the air duct and the later coagulation thereof being prevented.

Further, in such a solution, the sensitive air nozzle with a small cross-section is not in or directly at the driving nozzle, but is arranged at a protected location within the housing of the hot beverage machine. By such a device, the risk of leakages and the ingress of false air within the milk frothing nozzle or in particular within the driving nozzle is as far as possible prevented.

In particular, it may particularly preferably be provided that at the side of the air nozzle directed away from the driving nozzle, a valve is arranged.

It may particularly preferably be provided that the valve is electrically switchable.

The arrangement of an electrically switchable valve permits for instance for an electrical device control of the hot beverage machine to start or stop the supply of ambient air to the air nozzle and thus for mixing with milk and steam within the driving nozzle or in a mixing chamber arranged close to the driving nozzle.

Alternatively, it may particularly preferably be provided that the valve is electrically or mechanically controllable.

An electronically controllable valve could for instance be controlled by the electronic control system of the hot beverage machine, in order to produce a desired mixing ratio depending on the desired hot beverage. For this purpose, the electronic control system could further open the valve if is necessary or if applicable reduce the flow or if applicable close it.

For this purpose, it may particularly preferably be provided that the valve is formed by a needle or fine needle valve.

A needle or fine needle valve has proven itself in the field in particular in connection with the electronic control system of a hot beverage machine.

It may also particularly preferably be provided that the valve is formed by a switching valve, which has an additional connection for a cleaning medium such as water or steam.

The arrangement of such a switching valve permits by the additional connection for a cleaning medium the quick and simple cleaning of the air duct and if applicable activated by the control system of the hot beverage machine, so that even slight contaminations can be removed without any efforts by the user.

Thereby, the air duct of the hot beverage machine is rinsed, without parts of the hot beverage machine having to be disassembled and then reassembled again.

Particularly preferably is further provided that the driving nozzle ends in a mixing tube of the device in the section of a mixing chamber, the air duct is arranged in the body of the driving nozzle and ends beside the driving nozzle end in the mixing chamber, further the connection for supplying milk ends in the mixing chamber, a nozzle-type taper follows the mixing chamber in the direction of flow of the mixture, said taper leading to the outlet, and the air duct being on the feed side in connection with the air nozzle by a hose or the like.

An example of execution of the invention is shown in the drawing and is described in more detail in the following. There is:

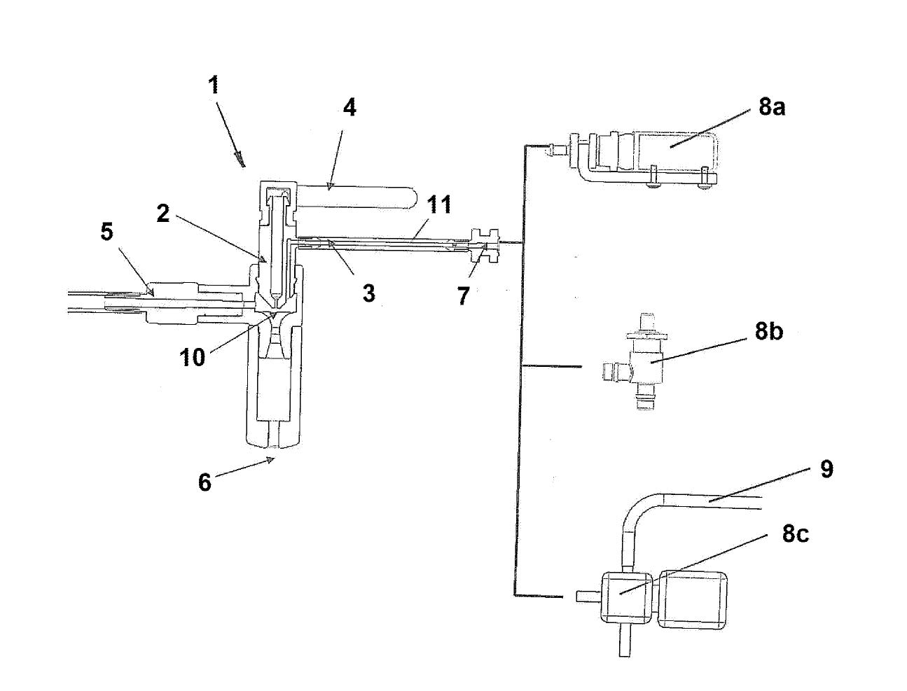

FIG. 1 a milk frothing nozzle according to the invention in a sectional side view with different possible valves.

In the Figure is shown a device for frothing milk. Such a device is normally arranged within the housing of a hot beverage machine. The device comprises at least one milk frothing nozzle 1, in which milk can be heated by means of steam produced externally in the device and can be mixed with ambient air. The device uses the principle of a jet pump. The milk frothing nozzle 1 comprises a driving nozzle 2 and an air duct 3 for supplying ambient air. Further, the milk frothing nozzle 1 comprises one connection 4 or 5, respectively, each for supplying steam as driving agent and milk. For discharging the produced milk foam, the milk frothing nozzle 1 comprises an outlet 6 for milk foam.

According to the invention, in the milk frothing nozzle 1, the air duct 3 is integrated in the driving nozzle 2 and has a free cross-section of at least 1 mm. To the air duct 3, in a section of the air duct 3 outside of the driving nozzle 2, an air nozzle 7 with a reduced cross-section is connected. The very sensitive air nozzle 7 is thus protected within the housing of the hot beverage machine. The free cross-section of the air nozzle 7 preferably is a few tenth millimeters.

At the side of the air nozzle 7 directed away from the driving nozzle 2, a valve 8a, 8b, 8c is arranged. The valve may be electrically switchable (8a). Alternatively, the valve may be electrically or mechanically controllable. For this purpose, a fine needle valve 8b may be used, since thereby a particularly exact control of the amount of air and thus the consistency of the produced milk foam is electrically adjustable. Further, it is also made possible by such a fine needle valve that different mixed milk beverages with differently high milk shares in the milk foam are produced. In another alternative, the valve 8 may also be a switching valve 8c, which has an additional connection 9 for a cleaning medium such as water or steam. By means of the additional connection 9 for the cleaning medium, the air duct 3 and the air nozzle 7 can quickly, easily and unnoticedly be cleaned by the user of the hot beverage machine, if necessary.

In the example of execution, the driving nozzle 2 ends in a mixing tube in the section of a mixing chamber 10. The air duct 3 is formed in the body of the driving nozzle 2 by a corresponding borehole or the like. It ends beside the end of the driving nozzle 2 in the mixing chamber 10. The connection 5 for supplying milk also ends in the mixing chamber 10, a nozzle-type taper following the mixing chamber 10 in the direction of flow of the mixture, said taper leading to the outlet 6. The air duct 3 is in connection with the air nozzle 7 by a hose 11.

The invention is not limited to this embodiment, but is in many ways variable within the scope of the disclosure.

All novel individual or combined features disclosed in the description and/or drawing are deemed essential for the invention.

1. A device for frothing milk in a hot beverage machine, at least comprising a milk frothing nozzle, in which milk can be heated by means of steam produced externally or internally in the device and can be mixed with ambient air, preferably using the principle of a jet pump, the milk frothing nozzle comprising at least a driving nozzle, an air duct for supplying ambient air, one connection each for supplying steam as driving agent and milk, and an outlet for milk foam, wherein the air duct is integrated in the driving nozzle and has an inner diameter of at least 1 mm, and that in a section of the air duct outside of the driving nozzle an air nozzle with a comparatively reduced cross-section is arranged.

2. The device for frothing milk according to claim 1, is wherein at the side of the air nozzle directed away from the driving nozzle, a valve is arranged.

3. The device for frothing milk according to claim 2, wherein the valve is electrically switchable.

4. The device for frothing milk according to claim 2, wherein the valve is electrically or mechanically controllable.

5. The device for frothing milk according to claim 4, wherein the valve is formed by a needle or fine needle valve.

6. The device for frothing milk according to claim 2, wherein the valve is formed by a switching valve, which has an additional connection for a cleaning medium such as water or steam.

7. The device according to claim 1, wherein the driving nozzle ends in a mixing tube of the device in the section of a mixing chamber, the air duct is arranged in the body of the driving nozzle and ends beside the driving nozzle end in the mixing chamber, further the connection for supplying milk ends in the mixing chamber, a nozzle-type taper follows the mixing chamber in the direction of flow of the mixture, said taper leading to the outlet, and the air duct being on the feed side in connection with the air nozzle by a hose or the like.
